(19) United States
(12) Patent Application Publication
(10) Pub. No.: US 2025/0365286 A1
(43) Pub. Date: Nov. 27, 2025

(54) ACCESS SECURITY APPARATUS AND METHOD FOR WIRELESS TELECOMMUNICATIONS NETWORK

(71) Applicant: Lenovo (Singapore) Pte. Ltd., Singapore (SG)

(72) Inventors: Sheeba Backia Mary BASKARAN, Friedrichsdorf (DE); Andreas KUNZ, Ladenburg (DE)

(21) Appl. No.: 18/874,767

(22) PCT Filed: Jun. 15, 2023
(86) PCT No.: PCT/IB2023/056221

§ 371 Date: Dec. 13, 2024

Related U.S. Application Data
(60) Provisional application No. 63/353,465, filed on Jun. 17, 2022.

(51) Int. Cl. H04L 9/40; H04W 12/60

(52) U.S. Cl. CPC H04L 63/101; H04L 63/20; H04W 12/66

(57) ABSTRACT

Various aspects of the present disclosure relate to performing security monitoring and trust evaluation of network and application functions and network slices, creating access control security policies based on trust data from the trust evaluation, and enforcing the access control security policies over service providers and consumers. The access control security policies may be updated and enforced on an ongoing basis.

### CROSS REFERENCE TO RELATED APPLICATIONS

This application claims priority to U.S. Provisional Patent Application No. 63/353,465, filed on Jun. 17, 2022, entitled ACCESS SECURITY APPARATUS AND METHOD FOR WIRELESS TELECOMMUNICATIONS NETWORK, which is hereby incorporated by reference in its entirety.

### TECHNICAL FIELD

The present disclosure relates to wireless communications, and more specifically to a method for providing security in a wireless telecommunications system, and a secure wireless telecommunications system.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

Conventional wireless communications systems are designed to secure against potential threats from outside the network. Internal network elements typically have implicit trust, so that when external security is breached, then a threat can propagate within the network. Accordingly, wireless communication networks can benefit from systems that limit the ability of threats to propagate within the networks.

### SUMMARY

The present disclosure relates to methods, apparatuses, and systems that support access security for wireless communication networks. Access security policies negotiated between network elements may limit the extent to which a threat can propagate within the wireless network.

Some implementations of the method and apparatuses described herein may further include a method comprising receiving, from a first network function, a subscribe request for access control security policies, transmitting, in response to the subscribe request, a subscribe response to the first network function, the subscribe response indicating that a policy subscription has been initiated, generating access control security policies for a plurality of network functions based on trust data derived from monitoring the respective network functions, applying validity parameters to the generated access control security policies, receiving an access control security policy creation request including at least one of a network function ID, a network function instance ID, an application function ID and a network slice ID, and transmitting a response to the access control security policy request, the response including at least one of a list of access control security polices for the identified network function, the identified network function instance, the identified application function, the identified network slice, and validity information, wherein the validity parameters are based on one or more of security monitoring data analytics validity, trust data analytics validity and local policy.

In some implementations of the method and apparatuses described herein, the method may further include transmitting a trust evaluation request to a second network function, the trust evaluation request including at least one of a trust data analytics indication, a network function identifier, a network function instance ID, an application function identifier, and a network slice identifier, transmitting a trust evaluation request to a second network function, the trust evaluation request including at least one of a trust data analytics indication, the network function ID, the network function instance ID, the application function ID, and the network slice ID, and receiving, from the first network function, a response to the trust evaluation request, the response including trust data associated with the identified network function, the identified network function instance, the identified application function, and the identified network slice. The second network function may be a trust evaluation function, and the first network function may be a network repository function.

In some implementations of the method and apparatuses described herein, the method may further include, before initiating the policy subscription, comparing a trust level of the first network function to a threshold value, wherein the policy subscription is only initiated when the trust level of the first network function exceeds the threshold value.

In some implementations of the method and apparatuses described herein, the method may further include receiving new trust data from the second network function, and transmitting an access control security policy request trigger message to the first network function in response to the new trust information.

In some implementations of the method and apparatuses described herein, the access control security policies include one or more of a network slice restriction list of network slices that can be offered as services, a network slice forbidden list of network slices that cannot be offered as services, a network service consumer restriction information list comprising one or more network function or application function permitted to consume a service after authentication and authorization, and a network service consumer forbidden list comprising one or more network function or application function forbidden from consuming a service.

In some implementations of the method and apparatuses described herein, the access control security policies include one or more of a trust data threshold for network service consumer authentication, a trust data threshold for network service consumer authorization, a trust data threshold for network producer authentication, a trust data threshold for network service discovery, a trust data threshold for network registration, a trust data threshold for network registration update, a network function service consumer authentication lifetime, a network function service consumer authorization lifetime, and a network function service producer authentication lifetime.

In some implementations of the method and apparatuses described herein, the access control security policies include one or more of a service operations restriction list comprising service names that can be offered as network function service producers, and a service operations forbidden list comprising service names that are not allowed to be offered as NF service producers.

In some implementations of the method and apparatuses described herein, the access control security policies include one or more of permitted UE context sharing, forbidden UE context sharing, restricted authentication lifetime, re-authentication periodicity, immediate connection termination recommendations, and least privilege authorizations.

### BRIEF DESCRIPTION OF THE DRAWINGS

FIG. 1 illustrates an example of a wireless communications system that supports access security in accordance with aspects of the present disclosure.

FIG. 2 illustrates an example of a block diagram of a device that supports access security in accordance with aspects of the present disclosure.

FIG. 3 illustrates a flowchart of a method that supports access security in accordance with aspects of the present disclosure.

FIG. 4 illustrates a signal diagram that supports access security in accordance with aspects of the present disclosure.

FIG. 5 illustrates a flowchart of a method that supports access security in accordance with aspects of the present disclosure.

FIG. 6 illustrates a signal diagram that supports access security in accordance with aspects of the present disclosure.

FIG. 7 illustrates a signal diagram that supports access security in accordance with aspects of the present disclosure.

### DETAILED DESCRIPTION

Various Network Functions (NF) s involved in a network, and in particular, an access network and core network, are allowed to communicate with each other following a mutual authentication based on Transport Layer Security (TLS) or Network Domain Security (NDS/IP) and authorization, for example by OAuth. Network functions involved in a cellular system such as a 5G system are implicitly trusted, so if a network function is under attack or is already compromised or hijacked, then there is a potential risk that even after successful mutual authentication and authorization, the compromised NF may remain malicious and unidentified.

Since authentication and authorization of NFs and Application Functions (AF) s are conventionally performed based on identity and pre-shared credentials, when a NF requests a connection or service, there is no way to assess the trustworthiness or security state of any NF or to apply appropriate policies and access controls based on real-time trust evaluation information. Therefore, existing security procedures such as authentication and authorization are not sufficient to identify compromised NFs, to apply appropriate access control policies to restrict the compromised NFs form accessing services, or to restrict service access to trusted NFs.

A compromised NF may impact other communicating NFs, such as consumers of services of the compromised NF, by allowing lateral movement of the attack, which may lead to network service failure. If allowed to provide service to UEs and other NFs in the network, the compromised NF can lead to various issues in the network such as data theft, service failure, denial of service, resource hijacking, etc.

Embodiments of the present disclosure mitigate threat propagation and the associated harms by providing trust-based access security policies to service/consumer relationships between NFs running on a wireless communications network. NFs may be continually monitored, and a trust level may be assigned to each NF on a network based on the results of the monitoring. When a NF seeks to initiate a service/consumer relationship with another NF, the network may apply a security policy to the relationship based on one or both of the trust levels of the NFs involved in the relationship. The security policy may be replaced or updated over time so that the security policy addresses threats as they emerge.

Embodiments of the present disclosure provide improved security compared to conventional networks. NFs in conventional networks typically establish service relationships using an authentication process which can reduce the likelihood of a malicious service request. However, it is possible to authenticate a compromised NF, so conventional networks have limited protection against internal threat propagation after a NF has been compromised. Embodiments of the present disclosure address this shortcoming by providing ongoing trust evaluation of NFs, and providing dynamic security policies that can react to changes in NF trust status. Accordingly, embodiments of the present disclosure provide higher levels of security than conventional networks.

Aspects of the present disclosure are described in the context of a wireless communications system. Aspects of the present disclosure are further illustrated and described with reference to device diagrams, flowcharts that relate to access security within a telecommunications network.

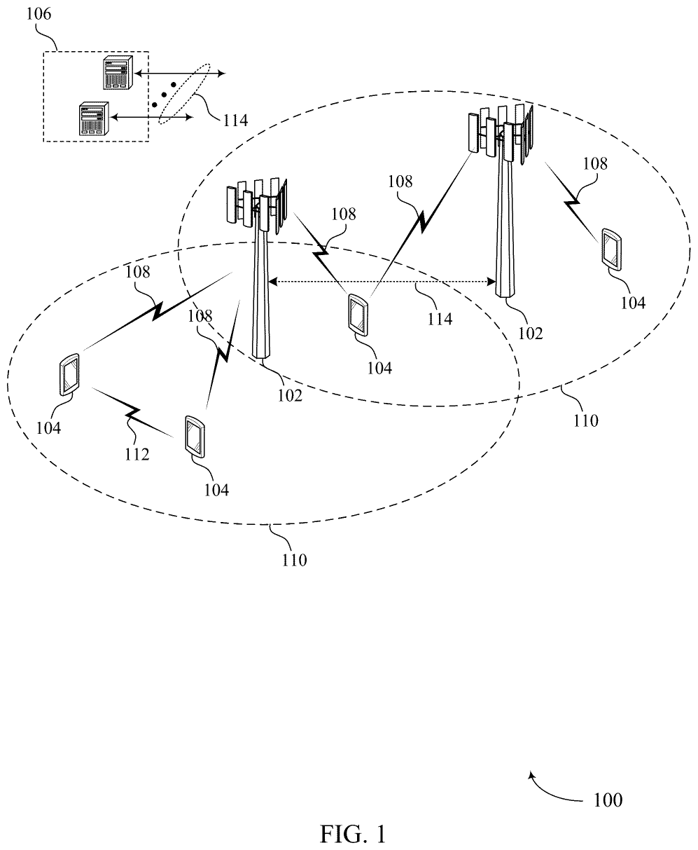

FIG. 1 illustrates an example of a wireless communications system 100 that supports access security in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

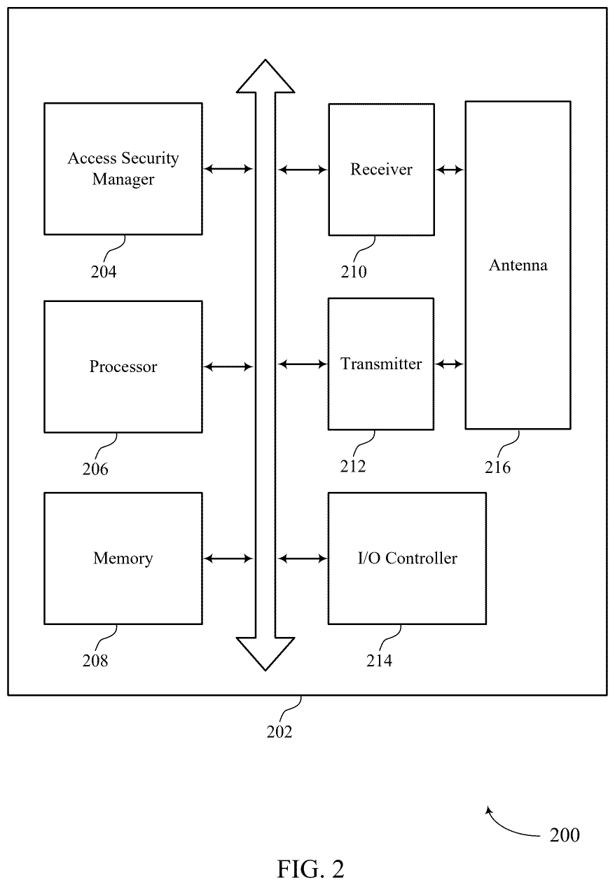

FIG. 2 illustrates an example of a block diagram of a device 200 that supports access security in accordance with aspects of the present disclosure. The device 202 may be an example of a computer in core network 106, a base station 102 or a UE 104 as described herein. The device 202 may support wireless communication with one or more base stations 102, UEs 104, or any combination thereof. The device 202 may include components for bi-directional communications including components for transmitting and receiving communications, such as a communications manager 204, a processor 206, a memory 208, a receiver 210, transmitter 212, and an I/O controller 214. These components may be in electronic communication or otherwise coupled (e.g., operatively, communicatively, functionally, electronically, electrically) via one or more interfaces (e.g., buses).

The communications manager 204, the receiver 210, the transmitter 212, or various combinations thereof or various components thereof may be examples of means for performing various aspects of the present disclosure as described herein. For example, the communications manager 204, the receiver 210, the transmitter 212, or various combinations or components thereof may support a method for performing one or more of the functions described herein.

In some implementations, the communications manager 204, the receiver 210, the transmitter 212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 206 and the memory 208 coupled with the processor 206 may be configured to perform one or more of the functions described herein (e.g., by executing, by the processor 206, instructions stored in the memory 208).

Additionally or alternatively, in some implementations, the communications manager 204, the receiver 210, the transmitter 212, or various combinations or components thereof may be implemented in code (e.g., as communications management software or firmware) executed by the processor 206. If implemented in code executed by the processor 206, the functions of the communications manager 204, the receiver 210, the transmitter 212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 204 may be configured to perform various operations (e.g., receiving, monitoring, transmitting) using or otherwise in cooperation with the receiver 210, the transmitter 212, or both. For example, the communications manager 204 may receive information from the receiver 210, send information to the transmitter 212, or be integrated in combination with the receiver 210, the transmitter 212, or both to receive information, transmit information, or perform various other operations as described herein. Although the communications manager 204 is illustrated as a separate component, in some implementations, one or more functions described with reference to the communications manager 204 may be supported by or performed by the processor 206, the memory 208, or any combination thereof. For example, the memory 208 may store code, which may include instructions executable by the processor 206 to cause the device 202 to perform various aspects of the present disclosure as described herein, or the processor 206 and the memory 208 may be otherwise configured to perform or support such operations.

For example, the access security manager 204 may support wireless communication at a first device (e.g., the device 202) in accordance with examples as disclosed herein. The communications manager 204 may be configured as or otherwise support access control security for a wireless communication network.

The processor 206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 206 may be configured to operate a memory array using a memory controller. In some other implementations, a memory controller may be integrated into the processor 206. The processor 206 may be configured to execute computer-readable instructions stored in a memory (e.g., the memory 208) to cause the device 202 to perform various functions of the present disclosure.

The memory 208 may include random access memory (RAM) and read-only memory (ROM). The memory 208 may store computer-readable, computer-executable code including instructions that, when executed by the processor 206 cause the device 202 to perform various functions described herein. The code may be stored in a non-transitory computer-readable medium such as system memory or another type of memory. In some implementations, the code may not be directly executable by the processor 206 but may cause a computer (e.g., when compiled and executed) to perform functions described herein. In some implementations, the memory 208 may include, among other things, a basic I/O system (BIOS) which may control basic hardware or software operation such as the interaction with peripheral components or devices.

The I/O controller 214 may manage input and output signals for the device 202. The I/O controller 214 may also manage peripherals not integrated into the device 202. In some implementations, the I/O controller 214 may represent a physical connection or port to an external peripheral. In some implementations, the I/O controller 214 may utilize an operating system such as iOS®, ANDROID®, MS-DOS®, MS-WINDOWS®, OS/2®, UNIX®, LINUX®, or another known operating system. In some implementations, the I/O controller 214 may be implemented as part of a processor, such as the processor 206. In some implementations, a user may interact with the device 202 via the I/O controller 214 or via hardware components controlled by the I/O controller 214.

In some implementations, the device 202 may include a single antenna 216. However, in some other implementations, the device 202 may have more than one antenna 216, which may be capable of concurrently transmitting or receiving multiple wireless transmissions. The receiver 210 and the transmitter 212 may communicate bi-directionally, via the one or more antennas 216, wired, or wireless links as described herein. For example, the receiver 210 and the transmitter 212 may represent a wireless transceiver and may communicate bi-directionally with another wireless transceiver. The transceiver may also include a modem to modulate the packets, to provide the modulated packets to one or more antennas 216 for transmission, and to demodulate packets received from the one or more antennas 216.

Embodiments of the present disclosure relate to a system, apparatus and method to set and configure dynamic access and security control policies based on real-time, dynamic trust evaluation information that can be used to enforce actions within the network. Exemplary actions include service consumption and provisioning restrictions, registration acceptance or denial, registration with reduced privileges, authentication acceptance or rejection, authentication with limited access time, authorization acceptance, rejection, or with least privileges, finer granular authorization, re-authentication, etc. Embodiments may restrict network communication to allow communication between only explicitly trusted NFs in the network and to limit or prevent service access for compromised or less trusted NFs.

The NFs may be any network function in the core network, network functions in the access network etc. An NF may be a network node or physical appliance. In some instances, an NF may be virtualized. NFs may be core network functions within the 5G system architecture.

A non-limiting list of some specific NFs within the scope of this disclosure is:
Authentication Server Function (AUSF),
Access and Mobility Management Function (AMF),
Data Network (DN), e.g. operator services, Internet access or 3rd party services,
Unstructured Data Storage Function (UDSF),
Network Exposure Function (NEF),
Network Repository Function (NRF),
Network Slice Admission Control Function (NSACF),
Network Slice-specific and SNPN Authentication and Authorization Function (NSSAAF),
Network Slice Selection Function (NSSF),
Policy Control Function (PCF),
Session Management Function (SMF),
Unified Data Management (UDM),
Unified Data Repository (UDR),
User Plane Function (UPF),
UE radio Capability Management Function (UCMF),
Application Function (AF),
User Equipment (UE),
(Radio) Access Network ((R)AN),
5G-Equipment Identity Register (5G-EIR),
Network Data Analytics Function (NWDAF),
CHarging Function (CHF),
Time Sensitive Networking AF (TSN AF),
Time Sensitive Communication and Time Synchronization Function (TSCTSF),
Data Collection Coordination Function (DCCF),
Analytics Data Repository Function (ADRF),
Messaging Framework Adaptor Function (MFAF),
Non-Seamless WLAN Offload Function (NSWOF),
Edge Application Server Discovery Function (EASDF),
Non-3GPP InterWorking Function (N3IWF),
Trusted Non-3GPP Gateway Function (TNGF),
Wireline Access Gateway Function (W-AGF), and
Trusted WLAN Interworking Function (TWIF).

The 5G System architecture also comprises the following network elements, which may be within the scope of elements to which security policies are applied:
Service Communication Proxy (SCP), and
Security Edge Protection Proxy (SEPP).

In an embodiment, an access security method supports confidence or trust evaluation values generated based on real-time, continuously updated trust evaluation information to be used for generation of access control policies and security policies at a policy control function (PCF). The access control policies and security policies generated at the PCF can be used to enforce dynamic access control during one or more of authentication, authorization, discovery, registration, service access request, data access, connection establishment, etc., at various NFs and AFs in the network to allow only explicitly trusted NFs and AFs to request and offer services in the network.

Trust evaluation information related to an NF or AF may be analytics information related to one or more of a security state, behavior, service operations, and environmental attributes of a network function and any information related to the network functional or operational security.

Examples of a security state include an observable state such as an installed software version, network or NF location, time or date of request, certificate status (e.g., expiry, renewal, revocation etc.), lack of configured credential rotation (e.g., if credential refreshment is not performed over a certain lifetime of the NF, the trust level can be impacted), previously observed behavior, installed credentials, telemetry data, data about what is happening inside an NF which can impact the business objectives and service experience, network function/network state, device state, interface state, applications running, open ports information, closed ports information, access or configuration violation information, expected configuration information, etc.

Behavior attributes may include automated subject analytics, device analytics, log analytics, measured deviations from observed usage patterns, etc. Service operations may include any deviations from regular and specified service operations. Environmental attributes may include factors such as requestor network location, time, reported active attacks, etc.

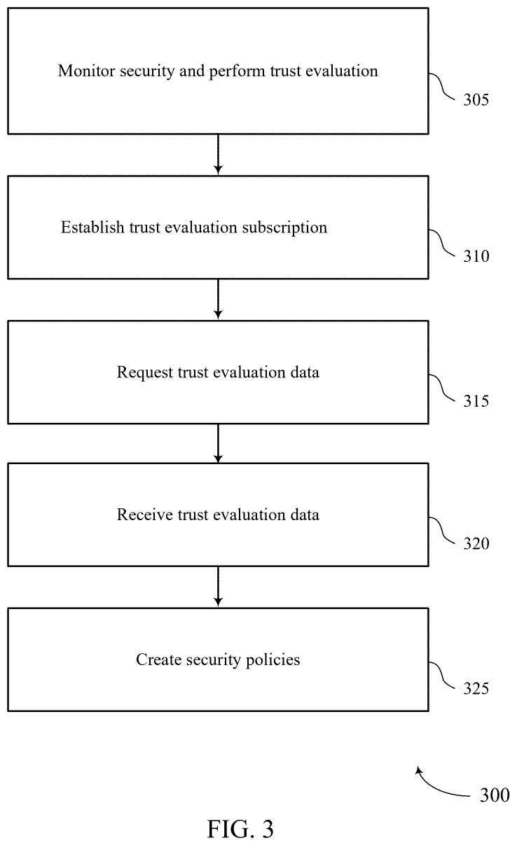

FIG. 3 illustrates a flowchart of a method 300 that supports access security in accordance with aspects of the present disclosure. The operations of the method 300 may be implemented by a device or its components as described herein. For example, the operations of the method 300 may be performed by a component of the core network 106, a base station 102 or a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 305, the method may include monitoring security and performing trust evaluation. The operations of 305 may be performed in accordance with examples as described herein. In some implementations, aspects of the operations of 305 may be performed by a device as described with reference to FIG. 1. Security monitoring and trust evaluation 305 may be performed on an ongoing basis for all NFs that are operating within a wireless network. Security monitoring and trust evaluation 305 may be initiated when an NF is installed or activated within the network.

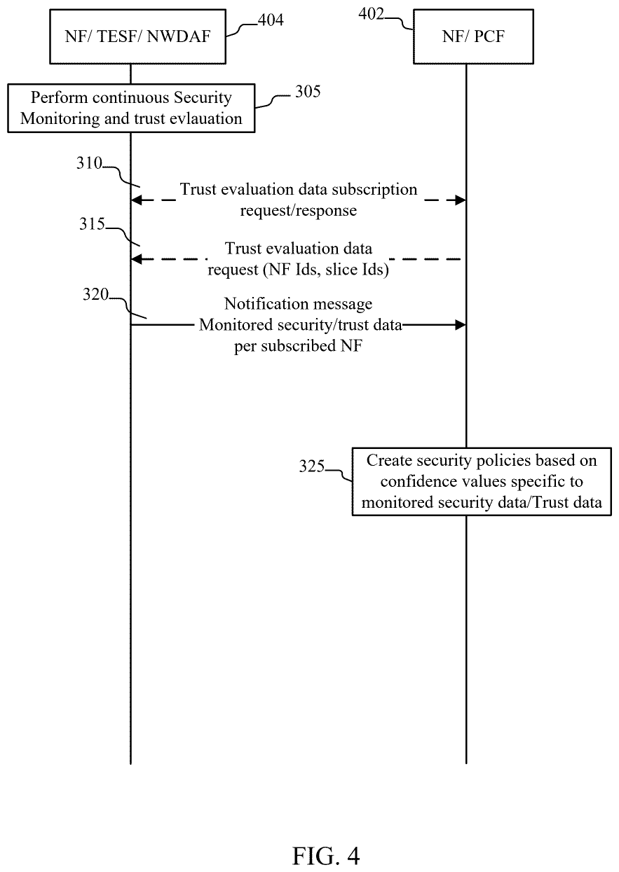

In an embodiment, method 300 is performed by an NF in communication with another NF within the same wireless communications network. An example of communications between two NFs performing an embodiment of method 300 is provided in FIG. 4. In an embodiment, method 300 may be performed by an NF 404, which may be a Policy Control Function (PCF), or some other NF configured to perform steps of method 300. For convenience of description, NF 404 will be referred to in the subsequent discussion as a PCF, but embodiments are not limited to this implementation.

PCF 402 may be in communication with an NF 404 which may be, for example, a Trust valuation service and enabler service function (TESF), a Network Data Analytics Function (NWDAF), or an NF that performs continuous dynamic security monitoring, trust evaluation and trust related analytics of various network functions, application functions or devices. The NF 404 may collect information about the observable state of network or application functions and evaluate the security posture and the related trustworthiness of those functions. For convenience of description, NF 404 will be referred to as TESF 404 in the following discussion.

In some embodiments, TESF 404 may apply artificial intelligence (AI)-based analytics operations to the trust evaluation information and generate one or more security confidence level, metric or range to categorize the trustworthiness of a particular function's security posture, operational behavior, service level, reliability, etc. The AI-based analytics operations may be operator specific trust evaluation algorithms, or other trust algorithms as known in the art.

An example of security confidence levels that may result from the evaluation at 305 is critical (e.g., 0-10%), very low, (e.g., 11-20%), low (e.g., 21-40%), medium (e.g., 41-60%), high (e.g., 61-80%), and very high (e.g., 81-100%). The precise number of intervals and the value of metrics or ranges associated with those levels may vary between different embodiments. These ranges may be referred to as trust data analytics information, security monitoring data analytics, or trust scores.

At 310, the method may include establishing a trust evaluation data subscription between PCF 402 and TESF 404. The operations of 310 may be performed in accordance with examples as described herein. In some implementations, aspects of the operations of 310 may be performed by a device as described with reference to FIG. 1.

A PCF 402 can subscribe to the TESF 404 to receive trust evaluation information, specific trust and/or security confidence levels, metrics or ranges for one or more NF or AF. Establishing the trust data subscription at 310 may include transmitting a trust evaluation data subscription request message from PCF 402 to TESF 404. The request message may include one or more NF ID or AF ID, and Network Slice Identification Information (e.g. NSSAIs/S-NSSAIs).

The TESF 404 may process the request based on local policy, and if the PCF 402 is evaluated and identified to be a trusted NF, then the TESF 404 may allow the subscription. The TESF 404 may then send a trust evaluation data subscription response that includes a success indication to PCF 402.

Alternatively, if TESF 404 evaluates the PCF 402 and determines that PCF 402 is a less trusted or untrusted function, then TESF 404 may deny the subscription. In that case, TESF 404 may transmit a trust evaluation data subscription response message with a reject and trust validation failure indication to PCF 402.

At 315, the method may include requesting trust evaluation data. The operations of 315 may be performed in accordance with examples as described herein. In some implementations, aspects of the operations of 315 may be performed by a device as described with reference to FIG. 1.

Following a successful subscription, PCF 402 may transmit a trust evaluation data request message to TESF 404 to fetch trust evaluation information including specific trust and/or security confidence levels for various NFs, AFs and network slices. The data request message may include an identifier of one or more NF, AF, or network slice for which the trust evaluation is sought. The timing of this message is not particularly limited, but it may be performed when an NF appears in the network, when the validation of current data expires, on a periodic basis, etc. In an embodiment, the message may be sent based on local policy.

At 320, the method may include receiving trust evaluation data. The operations of 320 may be performed in accordance with examples as described herein. In some implementations, aspects of the operations of 320 may be performed by a device as described with reference to FIG. 1.

The PCF 402 may receive trust evaluation data from TESF 404 in response to the request at 315. The trust evaluation data may be included in a notification message (e.g., a trust evaluation data notification) with trust evaluation information such as specific trust and/or security confidence levels, metrics or ranges along with an identifier of an NF, AF or network slice associated with the trust evaluation information. In addition, the trust evaluation data received at 320 may include validity information for the trust data analytics information. The validity information may provide a time for which the trust data is valid. The validity information may include an expiration time or period (e.g., x seconds/x minutes/x hours/x days/x years etc.,) set for the usage of the trust evaluation data. The same validity information can be considered for the validity of the access security policy derived based on the trust evaluation data.

At 325, the method may include creating security policies. The operations of 325 may be performed in accordance with examples as described herein. In some implementations, aspects of the operations of 325 may be performed by a device as described with reference to FIG. 1.

After receiving the trust evaluation data at 320, PCF 402 may generate an access control security policy for each NF or AF based on local policy. PCF 402 may set the validity for each access control security policy based on the validity of the trust data analytics, security monitoring data analytics and local policy. An access control security policy created at 325 may contain, for example, one or more of the following information:
a policy ID, which may identify a unique access control security policy;
a policy subscription ID, which may indicate a unique policy subscription;
a type of NF;
an ID of an associated NF or AF;
an ID of a network slice (for example, Network Slice Selection Assistance Information (NSSAI), Single Network Slice Selection Assistance Information (S-NSSAIs)) associated with an NF;
a service operations restriction list, which may include a list of service names that can be offered as NF service producers in view of the trust evaluation data;
a service operations forbidden list, which may include a list of service names that are not allowed as NF service producers in view of the trust evaluation data;
a network slice restriction list, which may include a list of SNSSAIs or NSSAIs that can be offered as service producers in view of the trust evaluation data;
a network slice forbidden list, which may include a list of SNSSAIs or NSSAIs that are not allowed to be offered as service producers in view of the trust evaluation data;
a network service consumer restriction list, which may include a list of one or more of NF types, NF IDs, AF IDs and service names that are allowed to consume services after authentication and authorization;
a network service consumer forbidden list, which may include a list of one or more of NF types, NF IDs, AF IDs and service names that are not allowed to consume services;
a trust data analytics/trust level threshold for Network service consumer authentication;
a trust data analytics/trust level threshold for Network service consumer authorization;
a trust data analytics/trust level threshold for Network producer authentication;
a NF service consumer Authentication lifetime, after which re-authentication is required;
a NF service consumer Authorization lifetime, after which re-authorization is required;
a NF service producer Authentication lifetime, after which re-authentication is required;
UE context sharing restrictions, which may include a list of UE context for which sharing is permitted, and may be specific to UE IDs, security context, local information, subscription data, UE related analytics or UE data;
forbidden UE context sharing, which may include a list of UE context for which sharing is forbitten, and may be specific to UE IDs, security context, local information, subscription data, UE related analytics or UE data;
a restricted authentication validity list, which may include a variety of permitted authentications such as NF service producer authentication, NF service consumer authentication, NRF authentication, and AF authentication;
re-authentication periodicity;
immediate connection termination recommendations; and least privilege authorizations for network service consumers to limit those consumers to a restricted set of services based on trust levels associated with the services and the potential security sensitivity of the services.

This list of information is not exclusive, and only a portion of the items on this list may be present in various embodiments. An access security policy may be NF specific, network slice specific, or service operation specific, for example. Accordingly, multiple security policies may be in place for a given network, and policies can be changed over time.

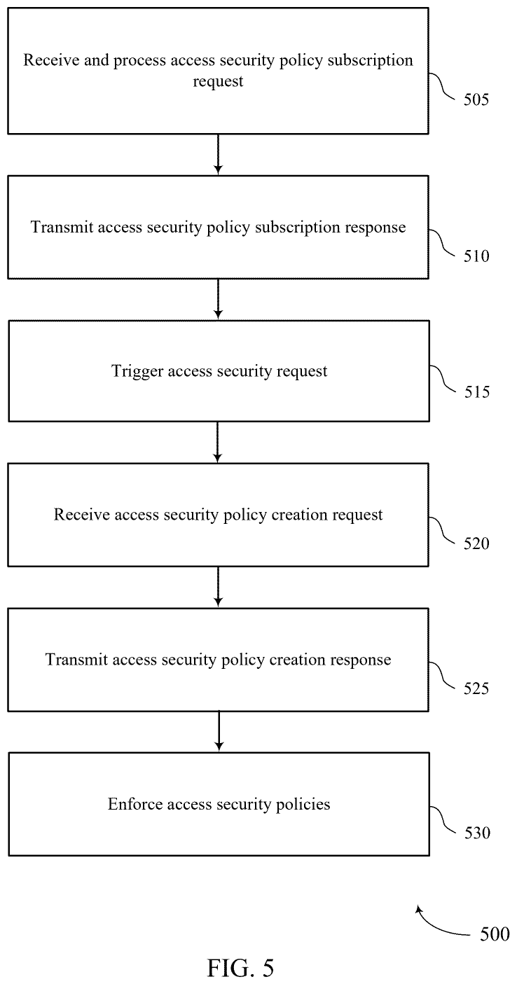

FIG. 5 illustrates a flowchart of a method 500 that supports access security in accordance with aspects of the present disclosure. The operations of the method 500 may be implemented by a device or its components as described herein. For example, the operations of the method 500 may be performed by a component of the core network 106, a base station 102 or a UE 114 as described with reference to FIGS. 1 and 2. In some implementations, the device may execute a set of instructions to control the function elements of the device to perform the described functions. Additionally, or alternatively, the device may perform aspects of the described functions using special-purpose hardware.

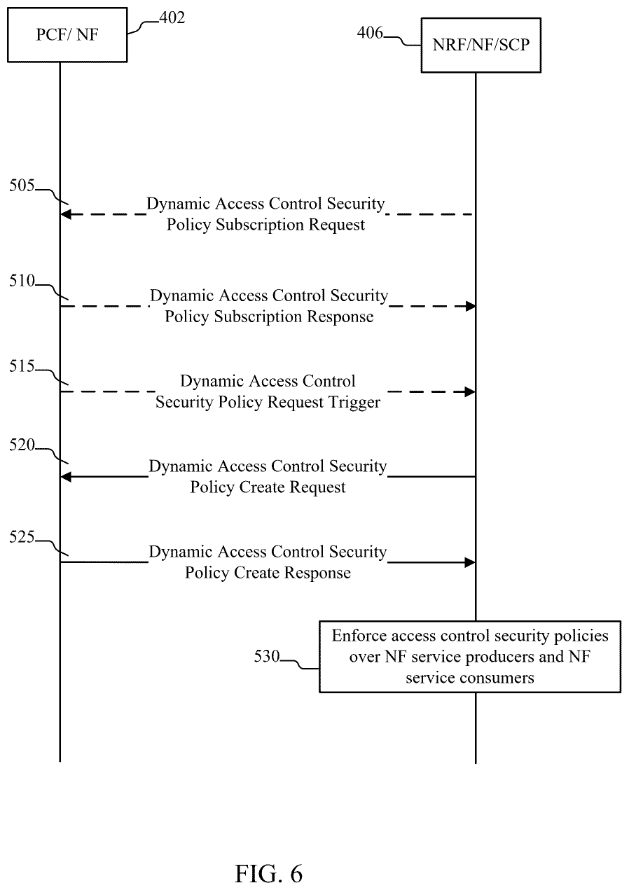

Elements of method 500 relate to the configuration and enforcement of dynamic access control security policies to allow only trusted NFs and AFs to be involved in any service provision or consumption within the network. Method 500 may be performed in conjunction with one or more element of method 300. For example, NRF 406 may enforce security policies from a PCF 402 created in method 300 at 325 in method 500. FIG. 6 illustrates a signal diagram in which an embodiment of method 500 is performed by a PCF 402 and an NRF 406.

At 505, the method may include receiving and processing an access security policy subscription request. The operations of 505 may be performed in accordance with examples as described herein. In some implementations, aspects of the operations of 505 may be performed by a device as described with reference to FIG. 1.

The entity that receives and enforces access control security policies from PCF 402 may be a NF 406, for example. For ease of description, element 406 will be referred to as a Network Repository Function (NRF), but embodiments are not so limited. In various embodiments, the element that receives and enforces access control security policies may be a Service Communication Proxy (SCP), or another NF or AF.

The NRF 406 may send a Dynamic Access Control Security policy subscription request message to PCF 402. This subscription request may include, for example, an ID of one or more NF, AF or network slice for which monitoring is desired, and service operation names for services of interest. Alternatively, NRF 406 can request to unsubscribe the Dynamic Access Control Security policy subscription by transmitting a Dynamic Access Control Security policy unsubscribe request with a policy subscription ID to PCF 402.

At 510, the method may include transmitting an access security policy subscription response message. The operations of 510 may be performed in accordance with examples as described herein. In some implementations, aspects of the operations of 510 may be performed by a device as described with reference to FIG. 1.

On receiving Dynamic Access Control Security policy subscription request, PCF 402 may determine whether the requesting NF is trusted based on the most recent trust range values or trust data analytics and local policy. If the requesting NF meets the trust requirements based on local policy, then PCF 402 may accept the subscription request. PCF 402 may then transmit a Dynamic Access Control Security policy subscription response message, which may include one or more of a success indication, and Ack and a Policy subscription ID.

Alternatively, if the trust range values or trust data analytics for the NF for which access is requested do not meet the trust requirements based on local policy, then PCF 402 determines to reject the subscription request at 505. In this case, the PCF 402 may transmit a Dynamic Access Control Security policy subscription response message with one or more of a reject indication, Negative-Ack and trust validation failure indication at 510.

In an embodiment, if the PCF 402 receives unsubscribe request, which may be a Dynamic Access Control Security policy unsubscribe request with a policy subscription ID, then the PCF 402 may delete the subscription and may transmit a Dynamic Access Control Security policy unsubscribe response message with a success indication/Ack.

At 515, the method may include transmitting a security policy request trigger. The operations of 515 may be performed in accordance with examples as described herein.

In some implementations, aspects of the operations of 515 may be performed by a device as described with reference to FIG. 1.

At any time, PCF 402 may receive the most recent trust evaluation information specific trust data analytics. That is, security monitoring may be performed continuously at 305, and PCF 402 may process trust data as it becomes available. If PCF 402 creates a new access control security policy, the PCF may transmit a Dynamic Access Control Security policy request trigger message to NRF 406 at 515. The trigger message may be transmitted periodically, any time based on local policy, or when trust status changes. The trigger message may include one or more of a policy subscription ID, NF ID, AF ID, Slice ID, and service operation name associated with the policy.

At 520, the method may include receiving a Dynamic Access Control Security policy create request message. The operations of 520 may be performed in accordance with examples as described herein. In some implementations, aspects of the operations of 520 may be performed by a device as described with reference to FIG. 1.

NRF 406 may transmit a Dynamic Access Control Security policy create request message to PCF 402 at 520. The create request message may include one or more of an NF ID, a network function instance ID, an AF ID, a network slice ID, and a service operation name. If there are multiple instances of an NF in a network, each NF instance may be identified with an NF Instance ID, so NF Instance IDs for affected NF instances may be provided in the create request message. In an embodiment, if the request message is sent as policy request, then the message may include an Access control security policy request indication to indicate that the request is for an Access control access security policy.

The create request message may be transmitted periodically, when the validity of an existing policy expires, following the reception of trigger message at 515, or at a time based on local policy. In some embodiments, the create request message may be transmitted when NF service producer or consumer related decisions are made—for example, during NF registration, authentication, authorization, etc.

At 525, the method may include transmitting a Dynamic Access Control Security policy create response message. The operations of 525 may be performed in accordance with examples as described herein. In some implementations, aspects of the operations of 525 may be performed by a device as described with reference to FIG. 1.

The PCF 402 may transmit a Dynamic Access Control Security policy create response message to NRF 406 at 525. The response message may include the most recent list of access control security policies specific to the policies requested at 520. For example, the response message may include identities of policies for one or more NF, AF, or network slice, the policies themselves, a NF instance ID, and IDs for each NF, AF or slice and validity data for the associated policies. If there are multiple instances of an NF in a network, each NF instance is identified with an NF Instance ID, and IDs of affected instances may be provided in the create response message.

In some embodiments, PCF 402 and NRF 406 may exchange messages related to access control security policies other than policy creation. For example, PCF 402 and NRF 406 may exchange messages for update, notify, update notify, and delete operations for Dynamic Access Control Security policies. For example, when an NF is deactivated or a service relationship with the NF is terminated, NRF 406 may transmit a Dynamic Access Control Security policy delete message to PCF 402 at 520. PCF 402 may delete the associated policy, and transmit an ACK notification message to NRF 406 at 525. Accordingly, the message exchange described with respect to 520 and 525 is not limited to messages for policy creation. In some embodiments, messaging for security policies may be initiated by the NRF.

At 530, the method may include enforcing access control security policies. The operations of 530 may be performed in accordance with examples as described herein. In some implementations, aspects of the operations of 530 may be performed by a device as described with reference to FIG. 1.

NRF 406 may store active Dynamic Access Control Security policies along with the associated NF ID, AF ID or Slice ID. NRF 406 may use the received Dynamic Access Control Security policies to enforce various access control related operations for any NF service consumer or NF service producers to allow or reject various operation such as NF service registration, NF discovery, NF authentication, NF service authorization, AF authentication, AF authorization, UE context sharing, etc.

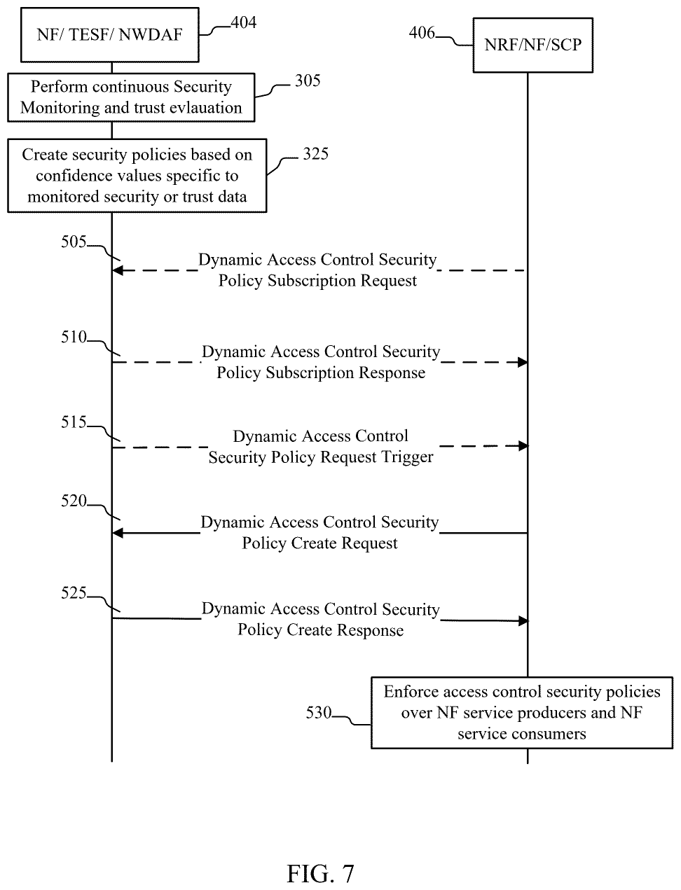

In an embodiment, as illustrated in FIG. 7, the TESF 404 may perform continuous security monitoring and trust evaluation at 305, and use data from the monitoring to create security policies at 325. In such an embodiment, a trust evaluation data subscription with PCF 402 may not be performed. In addition, the TESF 404 in the embodiment shown in FIG. 7 cooperates with NRF 406 to perform the steps of method 500 that are performed by PCF 402 in the embodiment shown in FIG. 6.

It is emphasized that the operations described with respect to FIGS. 3-7 are not limited to being performed by a TESF, PCF or NRF. In alternative embodiments, those operations may be performed by a different NF that is configured to generate or set access control policies and security policies related to monitored security information, evaluate trust data and enforce security policies for various trusted network operations. In addition, embodiments of the present disclosure apply to both roaming and non-roaming scenarios.

It should be noted that the methods described herein describe possible implementations, the operations and the steps may be rearranged or otherwise modified, and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication in a wireless network, the apparatus comprising:
a processor; and
a memory coupled with the processor, the processor configured to:
receive, from a first network function, a subscribe request for access control security policies;
transmit, in response to the subscribe request, a subscribe response to the first network function, the subscribe response indicating that a policy subscription has been initiated;
generate access control security policies for a plurality of network functions based on trust data derived from monitoring the respective network functions;
apply validity parameters to the generated access control security policies, the validity parameters indicating a time for which each access control security policy is valid;
receive an access control security policy creation request including at least one of a network function ID, a network function instance ID, an application function ID and a network slice ID; and
transmit a response to the access control security policy request, the response including at least one of a list of access control security polices for the identified network function, the identified network function instance, the identified application function, the identified network slice, and validity information,
wherein the validity parameters are based on one or more of security monitoring data analytics validity, trust data analytics validity and local policy.

2. The apparatus of claim 1, wherein the apparatus is further configured to:
transmit a trust evaluation request to a second network function, the trust evaluation request including at least one of a trust data analytics indication, the network function ID, the network function instance ID, the application function ID, and the network slice ID; and
receive, from the first network function, a response to the trust evaluation request, the response including trust data associated with the identified network function, the identified network function instance, the identified application function, and the identified network slice.

3. The apparatus of claim 2, wherein the second network function is a trust evaluation function.

4. The apparatus of claim 1, wherein the first network function is a network repository function.

5. The apparatus of claim 1, wherein the apparatus is further configured to:
before initiating the policy subscription, compare a trust level of the first network function to a threshold value,
wherein the policy subscription is only initiated when the trust level of the first network function exceeds the threshold value.

6. The apparatus of claim 1, wherein the apparatus is further configured to:
receive new trust data from the second network function; and
transmit an access control security policy request trigger message to the first network function in response to the new trust information.

7. The apparatus of claim 1, wherein the access control security policies include one or more of:
a network slice restriction list of network slices that can be offered as services,
a network slice forbidden list of network slices that cannot be offered as services,
a network service consumer restriction information list comprising one or more network function or application function permitted to consume a service after authentication and authorization, and
a network service consumer forbidden list comprising one or more network function or application function forbidden from consuming a service.

8. The apparatus of claim 1, wherein the access control security policies include one or more of:
a trust data threshold for network service consumer authentication,
a trust data threshold for network service consumer authorization,
a trust data threshold for network producer authentication,
a trust data threshold for network service discovery,
a trust data threshold for network registration,
a trust data threshold for network registration update,
a network function service consumer authentication lifetime,
a network function service consumer authorization lifetime, and
a network function service producer authentication lifetime.

9. The apparatus of claim 1, wherein the access control security policies include one or more of:
a service operations restriction list comprising service names that can be offered as network function service producers, and
a service operations forbidden list comprising service names that are not allowed to be offered as NF service producers.

10. The apparatus of claim 1, wherein the access control security policies include one or more of:
permitted UE context sharing,
forbidden UE context sharing,
restricted authentication lifetime,
re-authentication periodicity,
immediate connection termination recommendations, and
least privilege authorizations.

11. A method comprising:
receiving, from a first network function, a subscribe request for access control security policies;
transmitting, in response to the subscribe request, a subscribe response to the first network function, the subscribe response indicating that a policy subscription has been initiated;
generating access control security policies for a plurality of network functions based on trust data derived from monitoring the respective network functions;
applying validity parameters to the generated access control security policies;
receiving an access control security policy creation request including at least one of a network function ID, a network function instance ID, an application function ID and a network slice ID; and
transmitting a response to the access control security policy request, the response including at least one of a list of access control security polices for the identified network function, the identified network function instance, the identified application function, the identified network slice, and validity information,
wherein the validity parameters are based on one or more of security monitoring data analytics validity, trust data analytics validity and local policy.

12. The method of claim 11, further comprising:
transmitting a trust evaluation request to a second network function, the trust evaluation request including at least one of a trust data analytics indication, the network function ID, the network function instance ID, the application function ID, and the network slice ID; and
receiving, from the first network function, a response to the trust evaluation request, the response including trust data associated with the identified network function, the identified network function instance, the identified application function, and the identified network slice.

13. The method of claim 12, wherein the second network function is a trust evaluation function.

14. The method of claim 11, wherein the first network function is a network repository function.

15. The method of claim 11, further comprising:
before initiating the policy subscription, comparing a trust level of the first network function to a threshold value,
wherein the policy subscription is only initiated when the trust level of the first network function exceeds the threshold value.

16. The method of claim 11, further comprising:
receiving new trust data from the second network function; and
transmitting an access control security policy request trigger message to the first network function in response to the new trust information.

17. The method of claim 11, wherein the access control security policies include one or more of:
a network slice restriction list of network slices that can be offered as services,
a network slice forbidden list of network slices that cannot be offered as services,
a network service consumer restriction information list comprising one or more network function or application function permitted to consume a service after authentication and authorization, and
a network service consumer forbidden list comprising one or more network function or application function forbidden from consuming a service.

18. The method of claim 11, wherein the access control security policies include one or more of:
a trust data threshold for network service consumer authentication,
a trust data threshold for network service consumer authorization,
a trust data threshold for network producer authentication,
a trust data threshold for network service discovery,
a trust data threshold for network registration,
a trust data threshold for network registration update,
a network function service consumer authentication lifetime,
a network function service consumer authorization lifetime, and
a network function service producer authentication lifetime.

19. The method of claim 11, wherein the access control security policies include one or more of:
a service operations restriction list comprising service names that can be offered as network function service producers, and
a service operations forbidden list comprising service names that are not allowed to be offered as NF service producers.

20. (canceled)

21. A processor for wireless communication, comprising:
at least one controller coupled with at least one memory and configured to cause the processor to:
receive, from a first network function, a subscribe request for access control security policies;
transmit, in response to the subscribe request, a subscribe response to the first network function, the subscribe response indicating that a policy subscription has been initiated;
generate access control security policies for a plurality of network functions based on trust data derived from monitoring the respective network functions;
apply validity parameters to the generated access control security policies, the validity parameters indicating a time for which each access control security policy is valid;
receive an access control security policy creation request including at least one of a network function ID, a network function instance ID, an application function ID and a network slice ID; and
transmit a response to the access control security policy request, the response including at least one of a list of access control security polices for the identified network function, the identified network function instance, the identified application function, the identified network slice, and validity information,
wherein the validity parameters are based on one or more of security monitoring data analytics validity, trust data analytics validity and local policy.
